(19) United States
(12) Patent Application Publication
(10) Pub. No.: US 2007/0250547 A1
(43) Pub. Date: Oct. 25, 2007

(54) Log Preservation Method, and Program and System Thereof

(76) Inventors: Satoshi Kai, Yokohama (JP); Masato Arai, Yokohama (JP); Akira Morita, Yokohama (JP); Naoto Sato, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/691,581

(22) Filed: Mar. 27, 2007

(30) Foreign Application Priority Data
Apr. 7, 2006 (JP) 2006-106172

(51) Int. Cl. G06F 17/30

(52) U.S. Cl. 707/202

(57) ABSTRACT

An agent program 141 stores a log file in a storage device 150. By controlling an access to the storage device 150 according to volume management information 153, the storage device 150 prevents the log file from being updated. A manager program 142 communicates with the agent program 141 to collect the log file. On the completion of the log collection, the manager program 142 adds a signature to a log deletion message by use of a security chip 105. Then, the agent program 141 verifies the signature by use of a security chip 104 to judge that a log deletion request is valid. After that, the volume management information 153 which has been used to protect the log file is rewritten so that the protection is removed.

### INCORPORATION BY REFERENCE

This application claims priority based on a Japanese patent application, No. 2006-106172 filed on Apr. 7, 2006, the entire contents of which are incorporated herein by reference.

### BACKGROUND OF THE INVENTION

The present invention relates to log preservation techniques in which a server collects a log acquired in a client.

As a result of the complete enforcement of the Personal Information Protection Law, and the scheduled establishment of the Japanese version of the SOX law (the Sarbanes-Oxley law, the corporate reform law), it is required to acquire and store an operation log or a data access log in a client PC as one of security measures. By acquiring the log in the client, if the leakage of personal information has been found out, it is possible to narrow down clients whose possibility of having leaked the personal information is high, and to trace a leakage route, for example, electronic mail, a USB flash memory, a printed matter, or the like. In addition, the acquisition of the log makes it possible to prove that an operation which is out of compliance with a specified security policy has not been performed in the client, to an external auditor. Accordingly, the log acquisition is also useful from the viewpoint of legal compliance.

The log which has been acquired in a client can be stored in the client. However, because the log must be preserved, and because clients usually have limited resources, it is desirable that the log be collected by a server. However, because clients are often portable, each client is not always connected to the server when it is used. Therefore, it becomes necessary to preserve the log acquired in the client so that the log is locally kept stored in the client until the server collects the log. In particular, it is necessary to prevent the log, which has been written once, from being arbitrarily updated.

Under such circumstances, in recent years, the technique for preventing data written once from being updated, which is called WORM (Write Once Read Many), is known. The WORM shows characteristics of data; more specifically, although data written once cannot be updated, only reference to the data is allowed. Hereinafter, data having characteristics of WORM is referred to as “WORM data”. Japanese Patent Application Laid-Open No. 2005-339191 discloses the remote copying method in which when a remote copying is made between two WORM storage devices, a judgment is made as to whether or not target data is WORM data, before the remote copy is made. If this method is used, a log is locally written to a client as WORM data. This makes it possible to prevent the log from being falsified while the log is kept stored in the client. Moreover, because a WORM attribute of the log is inherited even after the log is remotely copied to a server, it is also possible to prevent the copied log stored in the server from being falsified. Such a WORM attribute is manually set from a management terminal.

### SUMMARY OF THE INVENTION

However, in the method disclosed in the above-described document, processing to be performed after the server collects the log, which has been acquired in the client, is not taken into consideration. To be more specific, after the server collects the log, it is not necessary to keep the log stored in the client. If the log is kept stored in the client, the capacity of the WORM storage device of the client becomes insufficient. In addition, when the WORM attribute is disabled, it is necessary to manually disable it from the management terminal, which is a laborious task. Moreover, if an operation error occurs, there is a possibility that the log will be falsified.

As described above, in the conventional techniques, even if the log which has been acquired in the client is collected by the server so as to preserve the log, resources of the client are consumed. In addition, it was not possible to prevent the log from being falsified as a result of an operation error of the management terminal.

Therefore, the present invention provides a log preservation technique in which when the log acquired in the client is collected by the server, a log storage area on the client side can be efficiently and safely reused.

According to the present invention, there is provided a client-server system that writes a log file by monitoring user's operations and data accesses on the client side, and that collects the written log file by a server through a network so as to store the log file in the server, wherein:

the client prevents the locally written log file from being updated, and deletes the locally written log file after the server collects the log file; and after the server writes, to a storage device thereof, the log file that has been collected from the client, the server requests the client to delete the log file in question.

According to the present invention, a log-file writing area of a client can be reused safely and efficiently.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a diagram illustrating a configuration of a log preservation system according to an embodiment of the present invention;

FIG. 2 is a diagram illustrating, as an example, volume management information and file management information;

FIG. 3 is a flowchart illustrating an example of processing performed at the time of power-on of a client;

FIG. 4 is a flowchart illustrating write processing of writing to a storage device;

FIG. 5 is a flowchart illustrating, as an example, processing of collecting a log by a server;

FIG. 6 is a diagram illustrating state transition of the log collection according to the embodiment;

FIG. 7 is a diagram illustrating a life cycle of a client to which a log preservation system according to the embodiment is applied;

FIG. 8 is a diagram illustrating a configuration of access control policy data according to a second embodiment of the present invention; and

FIG. 9 is a flowchart illustrating write processing of writing to a storage device according to the second embodiment.

### DETAILED DESCRIPTION OF THE EMBODIMENTS

Embodiments of the present invention will be properly described in detail with reference to drawings as below.

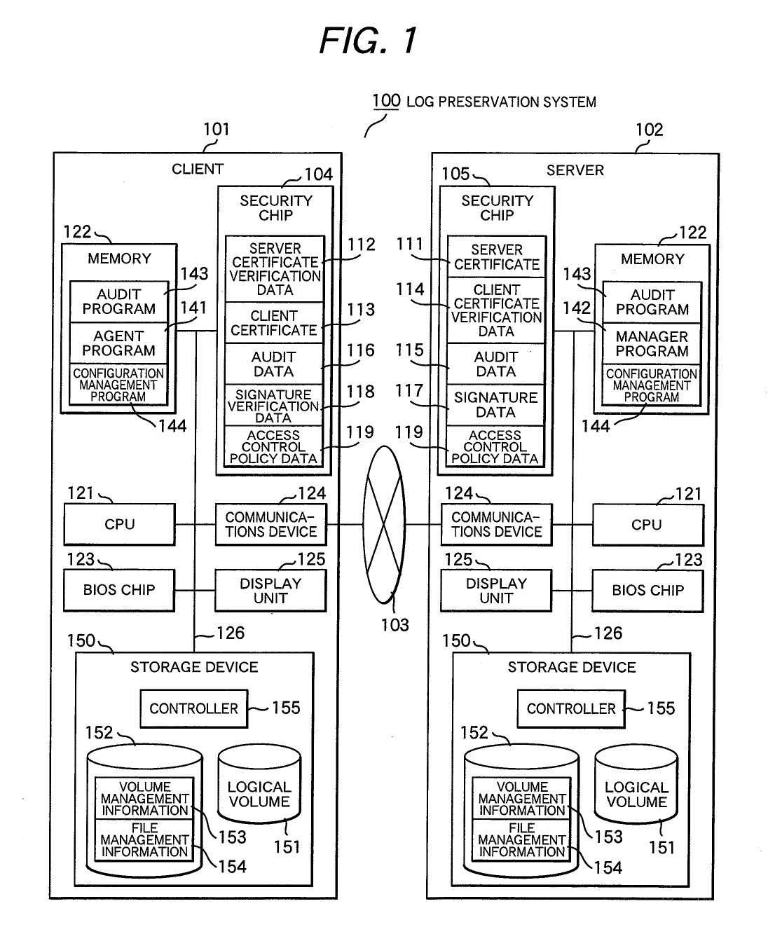

FIG. 1 is a diagram illustrating an overall configuration of a log preservation system according to an embodiment of the present invention. As shown in FIG. 1, a log preservation system 100 includes a client 101, and a server 102. The client 101 is connected to the server 102 through a network 103. Any kind of network (for example, TCP/IP network, ISDN line, and wireless LAN communications, or the like) may be used as the network 103 irrespective of the method used so long as it is a signal line that can be used for communications. Incidentally, the log preservation system 100 is applied to, for example, a client integration management system included in a corporate information system, an operator terminal management system located in a call center, and the like.

FIG. 1 also illustrates the block structure of the client 101. The client 101 includes: a CPU (Central Processing Unit) 121; a memory 122 such as a RAM that is a semiconductor memory; a storage device 150 in which data is kept stored even if the power is turned off; a communications device 124 for communicating through the network 103; a BIOS (Basic Input/Output System) chip 123 that performs starting processing immediately after the power of the client 101 is turned on; a display unit 125 such as a LCD (Liquid Crystal Display); a security chip 104 equipped with a storage area having tamper resistance, such as a TPM (Trusted Platform Module) chip proposed by the TCG (Trusted Computing Group). The security chip 104 has a unique ID that is assigned on a chip basis.

In addition, the above-described elements are mutually connected through a bus 126.

Here, the BIOS chip 123 stores a program group (BIOS) that detects devices (built-in devices and peripheral devices) connected to the bus 126, and that controls these devices.

In addition, the controller 155 controls operation of the storage device 150. Moreover, the storage area included in the storage device 150 is partitioned into one or more logical volumes. The logical volume 151 is one of the logical volumes. Volume management information 153, which is used to manage an access to the logical volume, is written to the storage area 152 included in the storage device 150. In this embodiment, the volume management information 153 is written to the storage area 152 included in the storage device 150. However, the volume management information 153 may also be written to a memory other than the storage area 152 (for example, a flash memory of the controller 155).

The controller 155 controls an I/O request to access a logical volume by use of the volume management information 153. In addition, file management information 154 is information accessed by a configuration management program 144 described below.

The security chip 104 includes: server certificate verification data 112 that is used to verify a server certificate 111 described below; a client certificate 113 by which the client 101 is identified and authenticated by the server 102; audit data 116 including a program-file hash value of an agent program 141 described below and that of a configuration management program 144 described below, and information about devices connected to the bus 126; signature verification data 118 that is used to verify a message to which a signature is added by use of signature data 117 described below; and access control policy data 119 that indicates a policy for controlling an access to a file in the storage device 150.

The tamper resistance of the security chip 104 protects these pieces of data against accesses made by unauthorized procedures. Incidentally, the access control policy data 119 is not used in the first embodiment.

In the client 101 that is configured as described above, an audit program 143, the agent program 141, and the configuration management program 144 are loaded into the memory 122, and then the CPU 121 executes the above-described program group.

The audit program 143 is a program that checks whether or not the agent program 141 or the configuration management program 144 has been falsified.

The agent program 141 is a program that monitors user's operations and data accesses in the client 101, and that writes the result of the monitoring to the storage device 150 as a log, and also transmits the written log to the server 102. In addition, the agent program 141 is programmed so that when a log is written to the storage device 150, the log is written to a volume having a WORM attribute.

The configuration management program 144 is a program that monitors accesses to files in the storage device 150, and that manages the file management information 154. The configuration management program 144 constitutes a part of a file system included in the client 101.

In addition, FIG. 1 also illustrates the block structure of the server 102. Although detailed description thereof will be omitted here, the server 102 also has substantially the same configuration as that of the client 101. However, as a point of difference between the client 101 and the server 102, the server 102 has a function of the manager program 142 (more specifically, a function of collecting a log that has been acquired by the client 101). Moreover, the security chip 105 includes: a server certificate 111 by which the server 102 is identified and authenticated by the client 101; client certificate verification data 114 that is used to verify the client certificate 113; audit data 115 including a program-file hash value of the manager program 142 and that of the configuration management program 144, and information about devices connected to the bus 126; and signature data 117 that is used to add a signature to a message to be transmitted from the manager program 142 to the agent program 141.

In the server 102, the audit program 143, the manager program 142, and the configuration management program 144 are loaded into the memory 122, and then the CPU 121 executes the above-described program group.

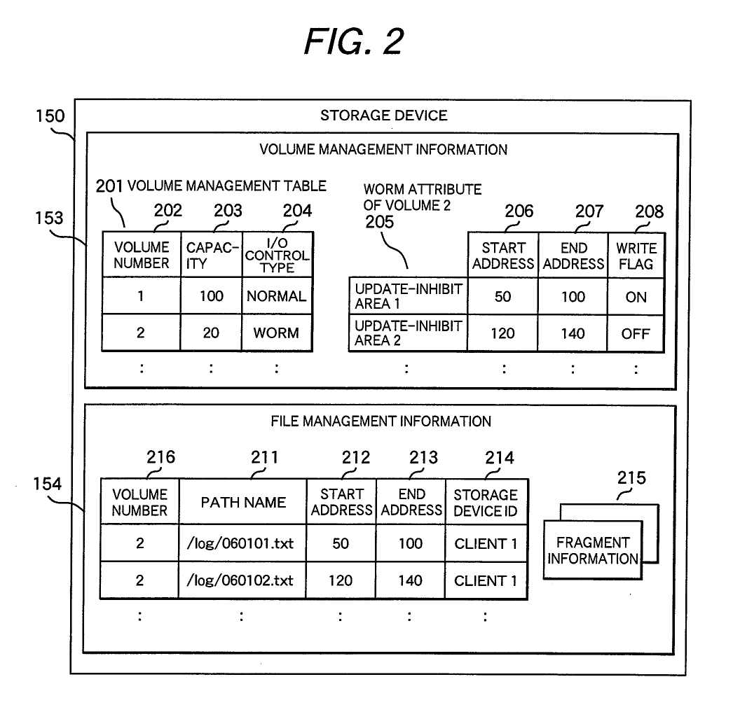

FIG. 2 is a diagram illustrating an example of the volume management information 153 and the file management information 154 that are stored in the storage device 150 of the client 101. Incidentally, the storage device 150 of the server 102 also stores and manages the volume management information 153 and the file management information 154 that are substantially the same as those stored on the client side.

The volume management information 153 includes: a volume management table 201; and a WORM attribute 205 corresponding to each volume whose WORM attribute is enabled, the WORM attribute being enabled/disabled on a volume basis.

The volume management table 201 includes the fields of a volume number 202, the capacity 203, and an I/O control type 204. The volume management table 201 is used to manage these pieces of information. The volume number 202 indicates a logical volume number. The capacity 203 indicates the storage capacity of a logical volume. Either “Normal” or “WORM” attribute is given to the I/O control type 204 by the configuration management program 144. If the I/O control type 204 of a volume is set at “Normal”, all sectors in the volume can be referred to and updated. On the other hand, if the I/O control type 204 of a volume is set at “WORM”, update of all sectors or some specific sectors is limited on the basis of conditions specified in the WORM attribute 205 described below.

The WORM attribute 205 includes information about a specified update-inhibit area, the number of which is 0 or more. The WORM attribute 205 includes the fields of: a start address 206 of an update-inhibit area; an end address 207 of the update-inhibit area; and a write flag 208 whose value is set at “ON” or “OFF”. These pieces of information are set by the configuration management program 144. The start address 206 and the end address 207 indicate a start sector number and an end sector number respectively. The write flag 208 indicates whether or not an update, or a write, to an update-inhibit area can be made once. “ON” indicates that an update, or a write, to the update-inhibit area can be made once, whereas “OFF” indicates that neither a write nor an update can be made. In an initial state, the write flag 208 is set at “ON”.

As information about sectors to which a file is written, the file management information 154 includes the fields of: a volume number 216; a path name 211; a start address 212 of a file specified by the path name 211; an end address 213 of the file specified by the path name 211; and a storage device ID 214. The file management information 154 is used to manage these pieces of information. As attribute information indicating where a file has been newly created, a unique ID of the security chip 104 is written to the field of the storage device ID 214. When the file is copied to the storage device of the server 102, the storage device ID 214 is inherited. Fragment information 215 includes management information used when a file is divided into a plurality of sectors to write the file. In the example shown in FIG. 2, a storage area of each log file corresponds to each update-inhibit area.

In this embodiment, the volume management information 153 and the file management information 154, which are stored in the server 102, are configured in the same manner as that of the volume management information 153 and the file management information 154 that are stored in the client 101. However, it is not necessary to configure the volume management information 153 and the file management information 154 on the server side to be completely the same as those of the client 101.

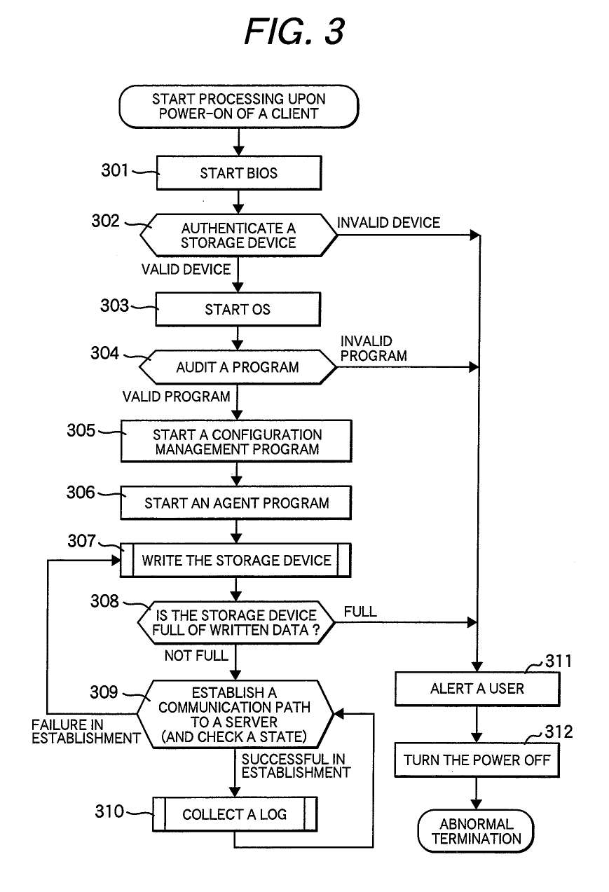

Next, the process flow of acquiring a log by the client 101 in the log preservation system 100, and the process flow of collecting the log by the server 102 in the log preservation system 100, will be described with reference to FIGS. 3 through 5.

FIG. 3 is a flowchart illustrating an example of processing performed at the time of power-on of the client 101.

When the power of the client 101 is turned on, BIOS is started from the BIOS chip 123 in a step 301. Next, in a step 302, by use of the audit data 116 stored in the security chip 104, the BIOS checks whether or not the storage device 150 connected to the bus 126 is a predetermined valid device. If it is judged that the storage device 150 is not a valid device, the BIOS issues an alert to the display unit 125 in a step 311, and then turns the power of the client 101 off in a step 312.

If it is judged in the step 302 that the storage device 150 is a valid device, the BIOS starts OS (Operating System) in a step 303. On the completion of the starting of the OS, in a step 304, the audit program 143 uses the audit data 116 stored in the security chip 104 to check whether or not the agent program 141 or the configuration management program 144 has been falsified. For example, the security chip 104 compares a program-file hash value written as part of the audit data 116 with a hash value of a program file (for example, the agent program 141), which is acquired at the time of executing the processing of the step 304. If both of the hash values coincide with each other, it is judged that the agent program 141 and the configuration management program 144 are valid programs. Then, the audit program 143 is notified of the result of the judgment. If it is not judged that the agent program 141 and the configuration management program 144 are valid programs, as is the case with the step 311, the audit program 143 issues an alert to the display unit 125. Then, as is the case with the step 312, the power of the client 101 is turned off.

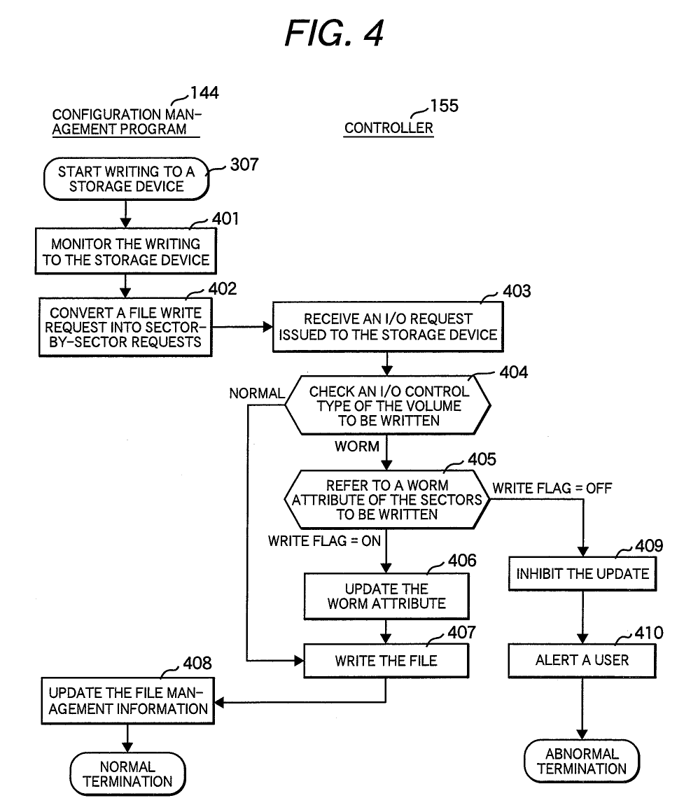

If it is judged in the step 304 that the agent program 141 and the configuration management program 144 are valid programs, the audit program 143 starts the configuration management program 144 in a step 305. Thereafter, the configuration management program 144 monitors all of accesses to the storage device 150 that are made in the client 101. Next, in a step 306, the agent program 141 is started. Thereafter, the agent program 141 monitors all of user's operations and data accesses that are made in the client 101. In a step 307, the agent program 141 writes the result of the monitoring to the storage device 150 as a log. The step 307 will be further described in detail with reference to FIG. 4.

In a step 308, the configuration management program 144 makes a judgment as to whether or not the storage device 150 is full of data. To be more specific, for example, if the size of a writable storage area of the storage device 150 is smaller than a specified value, the storage device 150 is judged to be full of data. If the storage device 150 is judged to be full, as is the case with the step 311, an alert is displayed on the display unit 125, and then as is the case with the step 312, the power of the client 101 is turned off. In another case, an alert may also be displayed on the display unit 125 of the server 102 in the step 312.

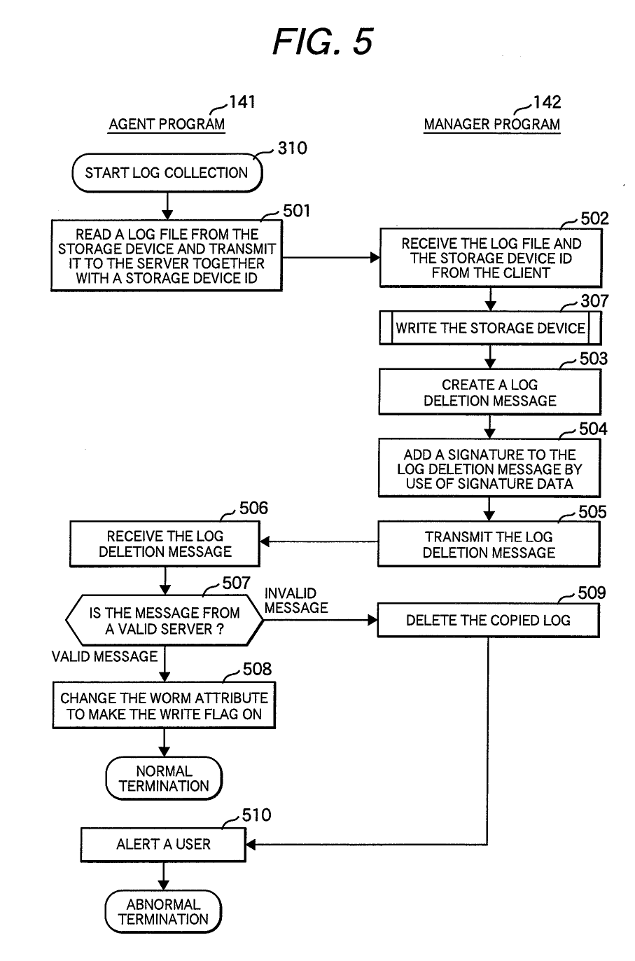

In a step 309, the agent program 141 tries to establish a communication path for communicating with the manager program 142. In order to establish the communication path, the agent program 141 first transmits the client certificate 113 of the security chip 104 to the server 102 through the communications device 124. The manager program 142 of the server 102 verifies the received client certificate 113 by use of the client certificate verification data 114 of the security chip 105. If the verification has succeeded, the manager program 142 transmits the server certificate 111 to the client 101 through the communications device 124. The agent program 141 verifies the received server certificate 111 by use of the server certificate verification data 112. If the verification has succeeded, a communication path between the client 101 and the server 102 is established by exchanging a key for encrypting the communication path. If all of the above-described processing has succeeded, then a log is collected from the storage device 150 of the client 101 in a step 310. The step 310 will be described in detail with reference to FIG. 5. In addition, if the establishment of the communication path has failed in the step 309, the process returns to the step 307.

As a result of the processing described above, the processing to be performed at the time of power-on of the client 101 ends. After that, the processing from the step 307 up to the step 310 is repeated until the power is turned off.

Incidentally, also at the time of power-on of the server 102, a flowchart of processing performed at this time is substantially the same as that shown in FIG. 3. However, as the processing specific to the server 102, in the step 304, the audit program 143 judges whether or not the manager program 142 and the configuration management program 144 are predetermined valid programs. In addition, in the step 306, the manager program 142 is started. Moreover, in the steps 309, 310, the manager program 142 collects a log from the agent program 141. The log collection processing performed in the server 102 will be described in detail with reference to FIG. 5.

Next, write processing of writing to the storage device 150, which was described in the step 307, will be described in detail with reference to FIG. 4. In the first embodiment, a WORM function of the storage device 150 is used to prevent a log file from being updated.

In a step 401, the configuration management program 144 monitors file accesses to the storage device 150 so as to detect writing. In a step 402, the configuration management program 144 refers to the file management information 154, and thereby converts a file write request, which is specified by a set of the volume number 216 and the path name 211, into the sector-basis I/O requests that are each specified by a set of the start address 212 and the end address 213. If the file management information 154 does not include information corresponding to a file write request, file management information about the file write request in question is added to the file management information 154 as a new entry. The file system to which the configuration management program 144 belongs issues each I/O request to the storage device 150.

In a step 403, the controller 155 accepts an I/O request issued to the storage device 150. Next, in a step 404, the controller 155 refers to the volume management table 201 of the volume management information 153 to check the I/O control type 204 of a target volume to be written. If the I/O control type 204 is “WORM”, in a step 405, the controller 155 refers to the WORM attribute 205 of the volume management information 153 to check the write flag 208 of the update-inhibit area to which the sectors to be written belong. If a write flag 208 is ON, in a step 406, the controller 155 secures a new sector area corresponding to the file requested by the file write request in the step 401, and then adds a new entry of an update-inhibit area of the WORM attribute 205. Moreover, the controller 155 sets the write flag 208 at “OFF”. After that, in a step 407, the file requested by the file write request in the step 401 is written to the logical volume 151.

In the step 404, if the I/O control type 204 of the target volume to be written is “Normal”, the file is written to the logical volume 151 as shown in the step 407.

In addition, in the step 405, if the write flag 208 is “OFF”, the controller 155 prohibits updating of a sector area in a step 409. Moreover, in a step 410, the controller 155 issues an alert to the display unit 125.

On the completion of the above-described processing of the controller 155, the control is returned to the configuration management program 144. Then, in a step 408, the configuration management program 144 updates entries of the file management information 154. To be more specific, if an entry of the file in question exists, the fields of the start address 212 and the end address 213 corresponding to the written area are updated. On the other hand, if the entry of the file in question does not exist, file management information is written to the fields ranging from the volume number 216 to the storage device ID 214. Incidentally, a unique ID possessed by the security chip 104 is written to the field of the storage device ID 214.

Incidentally, how to write a file to the storage device 150 of the server 102 is also the same as the flowchart shown in FIG. 4. This makes it possible to prevent a log file from being updated.

FIG. 5 is a flowchart illustrating in detail the flow of the log-file collection by the server 102 described in the step 310.

In a step 501, the agent program 141 reads out a log file written to the storage device 150, and then transmits the log file, and the storage device ID 214 of the file management information 154 corresponding to the log file, to the server 102 through the communication path established in the step 309.

In a step 502, the manager program 142 receives the log file and the storage device ID 214. Next, in a step 307, this log file is stored in the storage device 150 of the server 102. Here, the manager program 142 is programmed so that a log is written to a volume whose I/O control type 204 is “WORM”. Here, the detailed flowchart of writing the log to the storage device 150 is substantially the same as the processing shown in FIG. 4. However, there is one point of difference between them that the storage device ID 214 received in the step 502 is written to the file management information 154 in the step 408. On the completion of the writing of the log file to the storage device 150, in a step 503, a log deletion message is generated to the effect that the log file on the client 101 side may be deleted because the log file has already been stored. In this case, the log deletion message is configured to be different every time a log deletion message is issued. For example, the log deletion message is configured to include a hash value of the written log file. The reason why the log deletion message is changed every time is because such change makes it possible to prevent a log area from being illegally deleted by a replay attack. In a step 504, the manager program 142 adds a signature to the log deletion message by use of the signature data 117. In a step 505, the log deletion message having the signature is transmitted to the client 101.

In a step 506, the agent program 141 receives the log deletion message. In a step 507, the log deletion message is verified by use of the signature verification data 118 to judge whether or not the log deletion message has been transmitted from a valid server. If it is judged that the log deletion message has been received from a valid server, in a step 508, the configuration management program 144 is instructed to set at “ON” the write flag 208 of the WORM attribute 205 of the update-inhibit area specified in the volume management information 153, the update-inhibit area having been occupied by the file in question, and then to delete a corresponding sector area of the logical volume 151. Incidentally, when the sector area of the logical volume 151 is deleted, only deleting the file management information 154 including a path name 211 also suffices. In another case, the sector area of the logical volume 151 may also be deleted by, after overwriting the sector area of the logical volume 151 with specified characters, deleting the file management information 154 including a path name 211. Instill another case, the sector area of the logical volume 151 may also be deleted by, with the file management information 154 including a path name 211 being kept undeleted, overwriting the sector area of the logical volume 151 with specified characters to make the file size 0.

If it is judged in the step 507 that the log deletion message has been received from an invalid server, the agent program 141 requests the manager program 142 to delete the log that has been written to the storage device 155 of the server 102. In a step 509, the manager program 142 deletes the log. Further, in a step 510, the agent program 141 displays, on the display unit 125, an alert message to the effect that the log collection has failed.

By completing the above-described log collection processing, reuse of a log storage area in the storage device 150 of the client 102 becomes possible. This makes it possible to ensure the preservability of a log, and to prevent the free space of the storage device 150 from being inefficiently consumed.

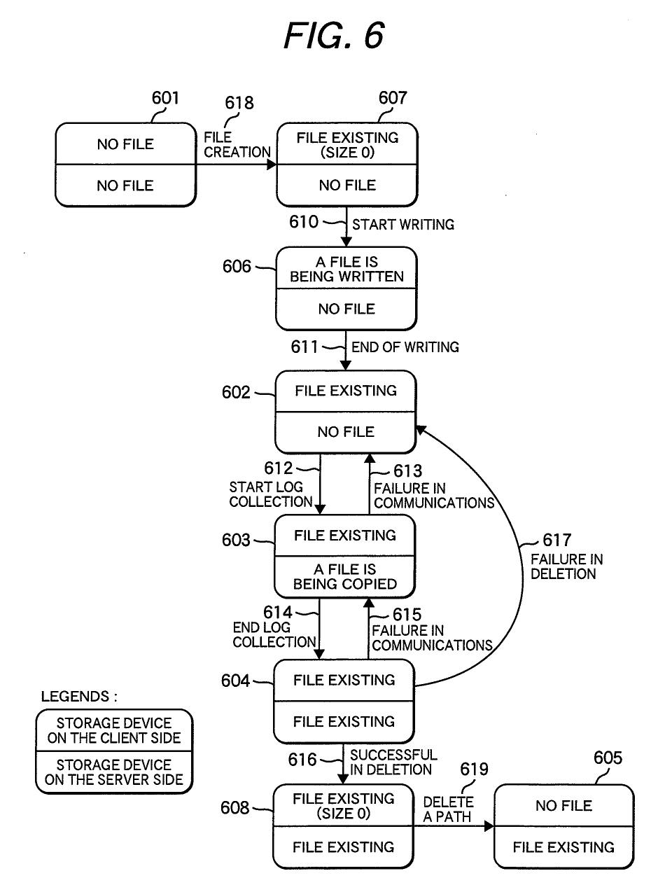

FIG. 6 is a diagram illustrating state transition in which a log file of the client 101 is collected by the server 102. First of all, each state will be described.

A state 601 is a state in which no log file exists in the client 101. A state 607 is a state in which a log file whose size is 0 is created in the storage device 150 of the client 101. A state 606 is a state in which a log file is being written to the storage device 150 of the client 101. A state 602 is a state in which the log file has been written to the storage device 150 of the client 101. A state 603 is a state in which a log file is being copied from the client 101 to the server 102. A state 604 is a state in which the log file has been copied from the client 101 to the server 102. A state 608 is a state in which the log file written to the storage device 150 of the client 101 has been deleted. A state 605 is a state in which a WORM protection area of the storage device 150 of the client 101 can be reused.

Next, state transition will be described with reference to FIG. 6. The transition from the state 601 to the state 607 is made by newly creating a log file (618). The transition from the state 607 to the state 606 is made by starting writing of the log file (610). The transition from the state 606 to the state 602 is made by completing the writing of the log file (611). The transition from the state 602 to the state 603 is made as a result of starting log collection (612). In addition, the transition from the state 603 to the state 602 is made at the time of the occurrence of an error such as a failure in communications (613) of a communication path that is required as a premise of the log collection. The transition from the state 603 to the state 604 is made by completing the log collection (614). In addition, the transition from the state 604 to the state 603 is made at the time of the occurrence of an error such as a failure in communications (615) of a communication path that is required as a premise of the log collection. The transition from the state 604 to the state 608 is made as a result of successfully deleting (616) of a log that has been written to the client 101. In addition, the transition from the state 604 to the state 602 is made at the time of the occurrence of an error including a failure in deletion (617) of a log. The transition from the state 608 to the state 605 is made as a result of successfully deleting (619) of a log that has been written to the client 101.

The above-described state transition diagram shows that a log which has been written to the client 101 is reliably collected by the server 102, and that the storage device 150 of the client 101 can be efficiently reused.

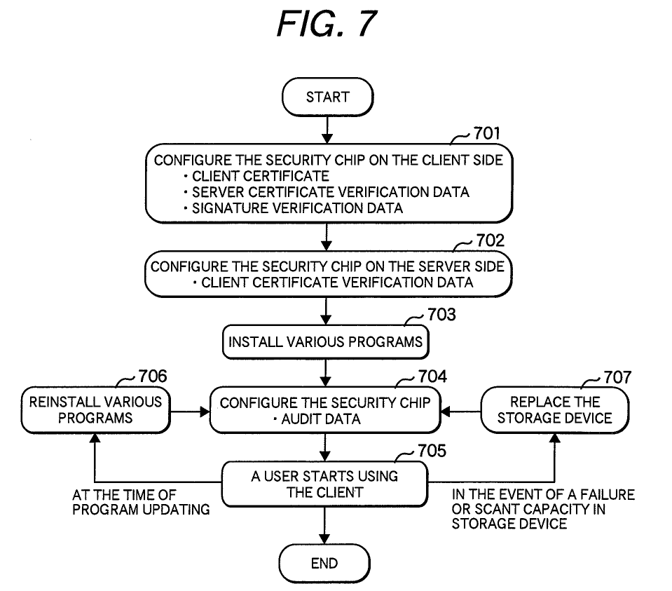

FIG. 7 is a diagram illustrating as an example a life cycle of the client 101 to which the log preservation system 100 is applied.

First of all, in a phase 701, the server certificate verification data 112, the client certificate 113, and the signature verification data 118 are configured to the security chip 104 on the client 101 side according to predetermined procedures. Here, the client certificate 113 is issued from a trustworthy certificate authority.

In a phase 702, the client certificate verification data 114, which is used to verify the client certificate 113 issued in the phase 701, is configured to the security chip 105 of the server 102 according to predetermined procedures. The server 102 stores the client certificate verification data 114 whose range covers all of the clients 101 to be managed.

In a phase 703, the audit program 143, the agent program 141, and the configuration management program 144 are installed on the client 101.

In a phase 704, the audit data 116 is configured to the security chip 104 of the client 101 according to predetermined procedures. The audit data 116 includes: a program-file hash value of the agent program 141 and that of the configuration management program 144; and configuration information of devices connected through the bus 126.

On the completion of the above-described phases, a user starts using the client 101 in a phase 705.

In the phase 705, if it is necessary to update the programs (for example, if a security hole is found in the agent program 141 or the configuration management program 144), in a phase 706, the various programs are reinstalled, and then as is the case with the phase 704, the audit data 116 is updated according to predetermined procedures.

In addition, in the phase 705, if the storage device 150 goes out of order, or if the amount of free space becomes smaller than or equal to a specified value, the storage device 150 is replaced in a phase 707, and then as is the case with the phase 704, the audit data 116 is updated according to predetermined procedures.

In this embodiment, the phase 705 corresponds to a point of time at which the client 101 has been given to the user. On the other hand, all of the other phases correspond to, for example, a point of time at which the client 101 has been given to a system administrator or a maintenance person.

In the first embodiment described above, the WORM function of the storage device 150 is used to prevent a log file from being updated. In a second embodiment, the storage device 150 does not have the WORM function. Therefore, as alternate means, the configuration management program 144 controls an access to the storage device 150 according to the access control policy data 119 to prevent a log file from being updated. This method of the second embodiment will be described as below. It is to be noted that the second embodiment does not use the WORM attribute 205 and the file management information 154.

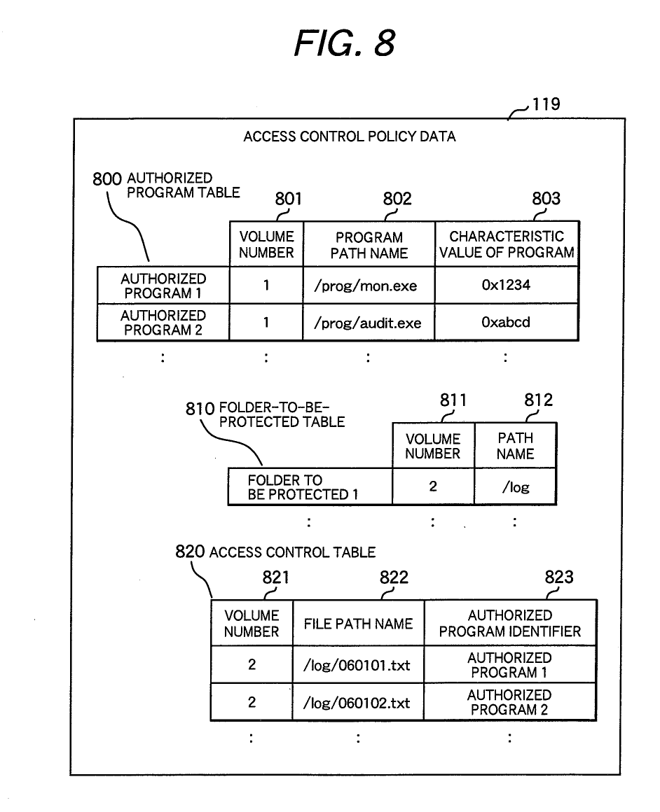

FIG. 8 is a diagram illustrating in detail the access control policy data 119. The access control policy data 119 includes the authorized program table 800, the folder-to-be-protected table 810, and the access control table 820.

The access control table 820 describes a policy of controlling an access to the storage device 150 by the configuration management program 144. To be more specific, if a target file to be accessed in the storage device 150 is a file specified by a set of the volume number 821 and the file path name 822, only an access from a program identified by the authorized program identifier 823 is permitted, whereas accesses from the other programs are prohibited. The volume number 821 is a number of a volume to which a file entity is written.

The authorized program table 800 specifies the programs that are each identified by the authorized program identifier 823 of the access control table 820. A program is uniquely identified by a set of the volume number 801 and the program path name 802; or a program is uniquely identified by a characteristic value of program 803 (for example, a hash value of a program file); or a program is uniquely identified by both of them. The volume number 801 is a number of a volume to which a file entity is written.

The folder-to-be-protected table 810 is used to specify an area of a file to be protected, which is specified by the access control table 820. If a file exists in a folder specified by a set of the volume number 811 and the path name 812, this file is treated as a file to be protected by a policy included in the access control table 820.

Incidentally, instead of specifying entries of the folder-to-be-protected table 810 and those of the access control table 820 by a folder name or a file path name, the entries may also be specified by an address range of a storage area, for example, by start and end addresses of sectors.

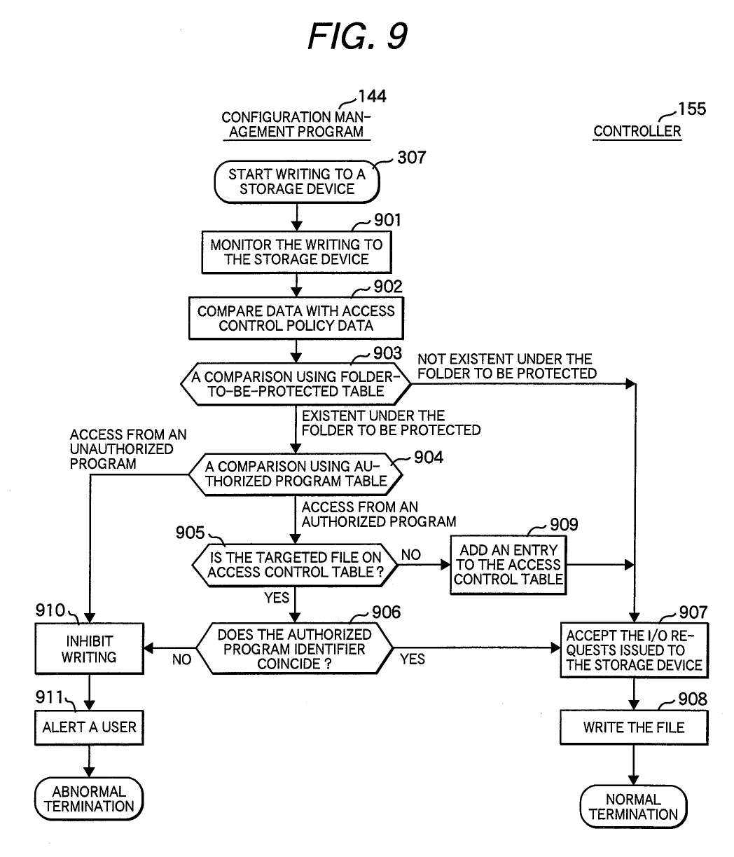

FIG. 9 is a flowchart illustrating how the configuration management program 144 according to the second embodiment operates. In a step 901, the configuration management program 144 monitors writing to the storage device 150. In a step 902, the access control policy data 119 stored in the security chip 104 is loaded, and then comparison is started. Incidentally, the configuration management program 144 may also be configured to keep the access control policy data 119 stored in the memory 122 once the access control policy data 119 is loaded into the memory 122.

In a step 903, a judgment is made as to whether or not a file to be written exists under a folder to be protected specified by the folder-to-be-protected table 810. If the file to be written does not exist under the folder to be protected, the conversion described in the step 402 is performed, and then the I/O requests are issued to the storage device 150. In a step 907, the controller 155 accepts the I/O requests issued to the storage device 150. Then, in a step 908, the file is written to the logical volume 151.

If it is judged in the step 903 that the file to be written exists under the folder to be protected, in a subsequent step 904, with reference to the authorized program table 800, a judgment is made as to whether or not a write request has been received from an authorized program that is permitted to write. If it is judged that the write request has been received from an unauthorized program that is not permitted to write, writing is inhibited in a step 910, and then in a subsequent step 911, an alert is issued to the display unit 125 to notify a user of it.

If it is judged in the step 904 that the write request has been received from the authorized program that is permitted to write, in a subsequent step 905, a judgment is made as to whether or not the access control table 820 includes the file to be written. In order to check whether or not the write request has been received from the authorized program, a characteristic value of the authorized program in question is transmitted from the configuration management program 144 to the security chip 105, and then the security chip 105 may compare the characteristic value with the characteristic value of program 803. On the basis of the result of the comparison, it may also be judged that the write request has been issued from the authorized program. If it is judged that the access control table 820 does not include the file to be written, an entry which permits a write request is added to the access control table 820 in a step 909, and the conversion and the issuance of the I/O requests are performed in the step 402, and then as is the case with the steps 907, 908, the file is written.

If it is judged in the step 905 that the access control table 820 include the file to be written, then in a subsequent step 906, a judgment is made as to whether or not the authorized program identifier 823 of the file to be written coincides with that of the file to be written included in the access control table 820. If both of the authorized program identifiers 823 coincide with each other, the conversion and the issuance of the I/O requests are performed in the step 402, and then as is the case with the steps 907, 908, the file is written. If they do not coincide with each other, as is the case with the steps 910, 911, writing is inhibited.

As a result of the processing described above, by prohibiting an access from programs other than the agent program 141, the configuration management program 144 can prevent a log file, which is written and added by the agent program 141, from being illegally updated.

In addition, according to the second embodiment, the processing performed in the client 101, which has received a log deletion message from the server 102, is substantially the same as that shown in FIG. 5. However, in the step 508, the agent program 141 instructs the configuration management program 144 to delete, from the access control table 820 of the access control policy data 119, an entry whose copying to the server 102 has been completed, and which has protected the log file. This processing is equivalent to deletion of the log file in question from the storage area.

Moreover, in the second embodiment, a life cycle of the client 101 is substantially the same as that shown in FIG. 7. However, in the step 704, the access control policy data 119 is written to the security chip 104 according to predetermined procedures.

According to the second embodiment described above, it is possible to prevent a log file, which has been written to the storage device 150, from being illegally updated. In addition to it, after the log file has been written to the server 102, it is possible to reuse the storage device 150 of the client 101 by the access control function of the configuration management program 144 without using the WORM function of the storage device 150.

The log preservation system described above can be applied to the whole range of client-server systems. Moreover, the log preservation system can be applied to not only client PCs but also portable devices including portable telephones and PDAs.

The specification and drawings are, accordingly, to be regarded in an illustrative rather than a restrictive sense. It will, however, be evident that various modifications and changes may be made thereto without departing from the spirit and scope of the invention as set forth in the claims.

We claim:

1. A log preservation method in which a client writes, as a log file, histories of user's operations and data accesses that are executed in the client, and in which a server collects the log file through a network and then stores the log file in the server, wherein:
the client executes the steps of:
when a write request to write the log file is received, if an attribute of a writing area in a storage device, to which the log file is to be written, is set at “write permitted”, writing the log file to the writing area, and then updating the attribute of the writing area to “write prohibited”; and
reading out the written log file, and transmit the log file in question to the server; and
the server then executes the steps of:
receiving the log file, and writing the log file to a storage device of the server;
transmitting, to the client, a message that instructs the client to delete the log file; and
the client then executes the step of:
receiving the message, and updating the attribute of the writing area to “write permitted”.

2. The log preservation method according to claim 1, wherein:
the storage device of the client keeps the attribute of the writing area stored; and
in response to an I/O request to write the log file, the storage device updates the attribute of the writing area to “write prohibited”, and then writes the log file to the writing area.

3. The log preservation method according to claim 1, wherein:
the server changes contents of the message every time each message is issued; and
when the client receives the message, if the message is valid, the client updates the attribute of the writing area to “write permitted”.

4. A log preservation method in which a client writes, as a log file, histories of user's operations and data accesses that are executed in the client, and in which a server collects the log file through a network and then stores the log file in the server, wherein:
the client executes the steps of:
if an authorized program, which is judged not to have been falsified, requests the client to write the log file to a log writing area in a storage device, writing the log file to the writing area; and
reading out the written log file, and transmitting the log file in question to the server;
the server then executes the steps of:
receiving the log file, and writing the log file to a storage device of the server; and
transmitting, to the client, a message that instructs the client to delete the log file; and
the client then executes the step of:
receiving the message, and deleting the log file from the log writing area.

5. The log preservation method according to claim 4, wherein:
a security chip of the client stores an identifier of the authorized program, information about the log writing area to be protected, and information about the log writing area to which the log file has been written.

6. The log preservation method according to claim 4, wherein:
the server changes contents of the message every time each message is issued; and
when the client receives the message, if the message is valid, the client deletes the log file.

7. A log preservation system comprising:
a client that writes, as a log file, histories of user's operations and data accesses that are executed in a computer on the client side; and
a server that collects the log file through a network and then stores the log file in the server,
wherein:
the client includes:
means for, when a write request to write the log file is received, if an attribute of a writing area in a storage device, to which the log file is to be written, is set at “write permitted”, writing the log file to the writing area, and then for updating the attribute of the writing area to “write prohibited”;
means for reading out the written log file, and then for transmitting the log file in question to the server; and
means for receiving, from the server, a message that instructs the client to delete the log file, and then for updating the attribute of the writing area to “write permitted”; and
the server includes:
means for receiving the log file, and then for writing the log file to a storage device of the server; and
means for transmitting the message to the client.

8. A log preservation system comprising:
a client that writes, as a log file, histories of user's operations and data accesses that are executed in a computer on the client side; and
a server that collects the log file through a network and then stores the log file in the server,
wherein:
the client includes:
means for, if an authorized program, which is judged not to have been falsified, requests the client to write the log file to a log writing area in a storage device, writing the log file to the writing area;
means for reading out the written log file, and then for transmitting the log file in question to the server; and
means for receiving, from the server, a message that instructs the client to delete the log file, and then for deleting the log file from the log writing area; and
the server includes:
means for receiving the log file, and then for writing the log file to a storage device of the server; and
means for transmitting the message to the client.

9. A program that instructs a computer on the client side to execute the step of writing, as a log file, histories of user's operations and data accesses which are executed in the client, and that instructs a computer on the server side to execute the step of collecting the log file through a network and then storing the log file in the server, wherein:
the program instructs the client to further execute the steps of:
when a write request to write the log file is received, if an attribute of a writing area in a storage device, to which the log file is to be written, is set at “write permitted”, writing the log file to the writing area, and then updating the attribute of the writing area to “write prohibited”;
reading out the written log file, and transmitting the log file in question to the server; and
receiving, from the server, a message that instructs the client to delete the log file, and then updating the attribute of the writing area to “write permitted”; and
the program instructs the server to further execute the steps of:
receiving the log file, and writing the log file to a storage device of the server; and
transmitting the message to the client.

10. A program that instructs a computer on the client side to execute the step of writing, as a log file, histories of user's operations and data accesses which are executed in the client, and that instructs a computer on the server side to execute the step of collecting the log file through a network and then storing the log file in the server, wherein:
the program instructs the client to further execute the steps of:
if an authorized program, which is judged not to have been falsified, requests the client to write the log file to a log writing area in a storage device, writing the log file to the writing area;
reading out the written log file, and transmitting the log file in question to the server; and
receiving, from the server, a message that instructs the client to delete the log file, and then deleting the log file from the log writing area; and
the program instructs the server to further execute the steps of:
receiving the log file, and writing the log file to a storage device of the server; and
transmitting the message to the client.
